(19) United States
(12) Patent Application Publication
(10) Pub. No.: US 2012/0023710 A1
(43) Pub. Date: Feb. 2, 2012

(54) Trailer Hitch-Ball Chain Coupler

(76) Inventors: David Wickstrom, Valley Mills, TX (US); Paul McMahan, McGregor, TX (US); Jon Ker, Valley Mills, TX (US)

(21) Appl. No.: 13/191,161

(22) Filed: Jul. 26, 2011

Related U.S. Application Data
(60) Provisional application No. 61/400,638, filed on Aug. 2, 2010.

(51) Int. Cl. F16G 15/04

(52) U.S. Cl. 24/116 R

(57) ABSTRACT

A tool for temporarily coupling a chain to a trailer hitch-ball or similar device, or for temporarily coupling separate chains comprising a rigid flat body contour plate with a hitch-ball cavity member for engagement with a trailer hitch-ball or similar device, an engagement slot member as a securing mechanism to the hitch-ball, and opposing chain link notches members for engagement of chain(s).

### CROSS-REFERENCE TO RELATED APPLICATIONS

This Application claims the benefit of Provisional Patent Application Ser. No. 61/400,638, filed Aug. 2, 2010 by the present inventors, which is incorporated herein by reference.

### FEDERALLY SPONSORED RESEARCH

None.

### SEQUENCE LISTING OR PROGRAM

None

### BACKGROUND OF THE INVENTION

1. Field

This invention generally relates to single-piece tools and hardware which are substantially flat, and relates specifically to the coupling of a chain to a trailer hitch-ball, similar device, or to another chain. This tool enables the securing of a chain to a trailer hitch-ball or similar device for towing, pulling or dragging objects, and for temporarily coupling separate chains for towing, pulling or dragging that is practical, efficient, and comparatively simple while inexpensive to manufacture.

2. Prior Art

Typically, chain couplers have related to designs to obtain the inter-connecting of the end links of two separate chains. Various methods have been patented to accomplish the coupling of these separate chains into one singular chain, and generally fall into two categories, the first being the use of clamping devices as exemplified by U.S. Pat. No. 3,822,549 to Reiger (1974) which uses cylindrical sleeve-like sockets to clamp to cooperating half-links of chain. The second general method is by the use of shackles or clevises as exemplified by U.S. Pat. No. 3,685,285 to Spilhaug (1972). These methods are typically designed to couple lengths of similar gauge chain links to permanently form one chain from two or more chains. The existing art does not provide a reusable tool for securely coupling a chain to a trailer hitch-ball or similar devise where the chain end is a link of the chain. Existing art also does not allow for situations where two chains are sought to be employed, but where existing art couplers are not available or are not practicable. Examples of such situations would be: (1) where the links of chain are of differing size or gauge and incapable of being coupled by existing methods, (2) where the user does not intend or desire to permanently couple separate lengths of chain to become one chain, (3) where the user wants to quickly couple a chain for use without the need for additional tools and hardware, or (4) where the user wants a simple one-piece mechanism for coupling a chain with or without the use of additional tools.

Chains are often used in conjunction with a towing or pulling vehicle to accomplish the dragging or pulling of objects. The towing or pulling vehicle often has a trailer hitch-ball but has no simple option or has only a limited way of securing the employed chain to the trailer hitch-ball of the vehicle. Additionally, even where a chain is capable of being attached to the towing or pulling vehicle or to a trailer hitch-ball on the vehicle, there are situations where it is necessary to temporarily couple two separate chains in order to complete the intended task. It is desirable to provide a simple one-piece tool capable of securely coupling temporarily a chain to a trailer hitch-ball of a vehicle or to temporarily and securely couple two separate chains for a task without the necessity of permanently combining or coupling such chains through the use or employment of additional hardware and other tools.

### SUMMARY OF THE INVENTION

In accordance with one embodiment a single-piece tool, this invention comprises a flat body contoured plate, a trailer hitch-ball cavity, a hitch-ball engagement slot and two opposing notches for chain link insertion. There are, of course, features of the invention which can be modified, or adjusted, or extended which also form the subject matter of the claims appended hereto. Those skilled in the art will appreciate that the conception, upon which this disclosure is based, may readily be utilized as a basis for the designing of other construction prototypes, using features and methodologies for carrying out various intentions and purposes of the present invention. It is important, therefore, that the claims be regarded as including such equivalent constructions in so far as they do not depart from the spirit and scope from the present invention.

### DESCRIPTION OF THE DRAWINGS

In the accompanying drawings, which are incorporated herein and constitute a part of this specification, embodiments of the invention are illustrated, which, together with a general description of the invention given above, and the detail description given below serve to illustrate the principles of this invention.

The drawings and detailed description are not intended to and do not limit the scope of the invention or the claims in any way. Instead, the drawings and detailed description only describe embodiments of the invention and other embodiments of the invention not described are encompassed by the claims.

FIG. 1 is a perspective view of the coupler.

FIG. 2 is an isometric illustration of the invention in use.

FIG. 3 is an isometric illustration of the invention in use.

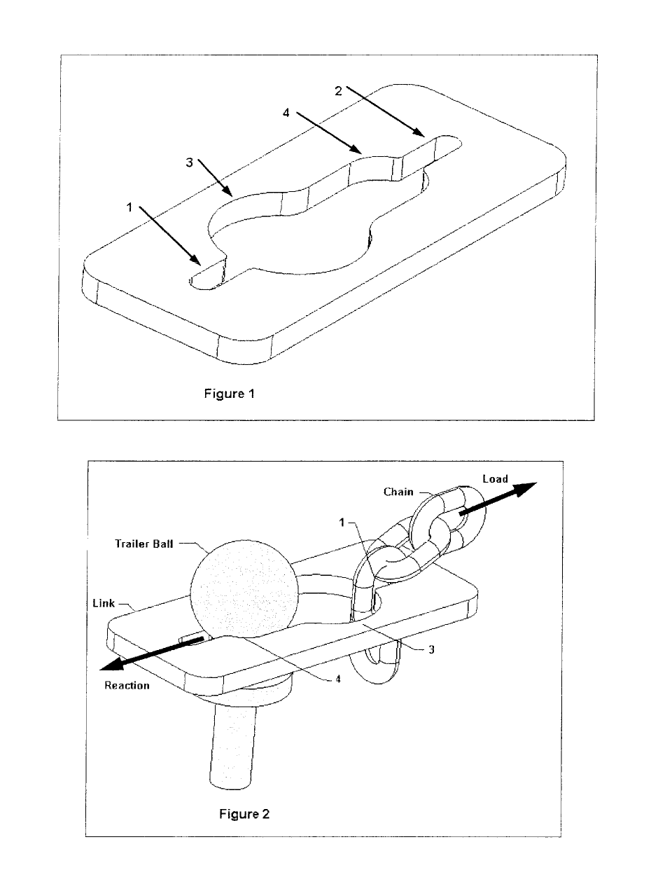

### DRAWINGS—REFERENCE NUMERALS

Reference Numerals 1 and 2 are opposing notches for chain links, where Reference Numeral 1 notch is the reaction notch and Reference Numeral 2 is the load notch. Reference Numeral 3 is the hitch-ball cavity, and Reference Numeral 4 is the hitch-ball engagement slot.

### DETAILED DESCRIPTION

The detailed description of the invention merely describes preferred embodiments of the invention and is not intended to limit the scope of the claims in any way.

### DETAILED DESCRIPTION AND OPERATION OF ALTERNATIVE EMBODIMENTS

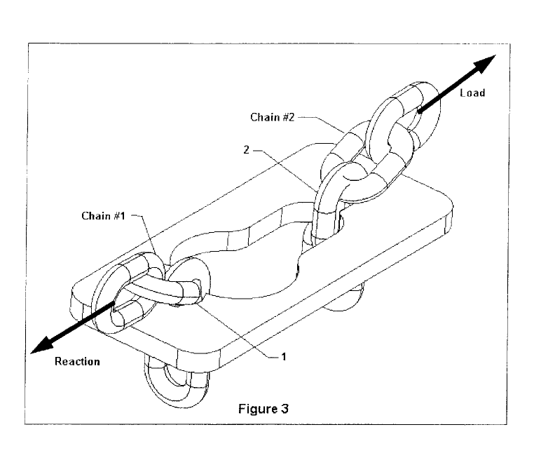

### (1) First Embodiment—FIG. 2

One embodiment of the Trailer Hitch-Ball Chain Coupler is illustrated in FIG. 2. The coupler has a hitch-ball cavity (Reference Numeral 3) through which the trailer hitch-ball proceeds until the coupler tool comes to rest upon the trailer hitch-ball base, allowing the coupler tool to slide between trailer hitch-ball and base such that the trailer hitch-ball and base rest snugly within the engagement slot (Reference Numeral 4). A chain link is inserted into the chain link notch (Reference Numeral 1) with the corresponding end of the chain attached to the object to be towed, pulled or dragged. During operation the coupler tool reacts to a force caused by the trailer hitch-ball bearing against the engagement slot (Reference Numeral 4), where the chain bears against the notch (Reference Numeral 1). The reaction force causes the coupler tool to remain secure against the trailer hitch-ball and base when there is a load bearing on the link notch (Reference Numeral 1). The locking feature of the chain is the chain itself, for the next link in the assembly is positioned 90 degrees from the attaching link being larger than the slot, bears out against the coupler tool housing. When a force is applied causing tension on the chain, the coupler engages with the trailer hitch-ball and acts as an attachment between the chain and the trailer hitch-ball.

### (2) Second Embodiment—FIG. 3

One embodiment of the coupler tool is illustrated in FIG. 3. In the embodiment demonstrated by FIG. 3 the coupler tool acts as a component between two separate chains. Chain #1 being the chain attached to the vehicle or other means of force, Chain #2 being attached to the load. In this embodiment a link from Chain #1 is inserted into chain link notch (Reference Numeral 1). A link from Chain #2 is inserted into chain link notch (Reference Numeral 2). In this embodiment a load is applied to Chain #2, and reacts to a force bearing on Chain #1. The chains are prevented from pulling through the hitch-ball cavity (Reference Numeral 3) or the hitch-ball engagement slot (Reference Numeral 4) by the load as Chain #1 bears against the notch at Reference Numeral 1, where Chain #2 bears against the notch at Reference Numeral 2. The locking feature of both chains is the chain itself, for the next link in the assembly is positioned 90 degrees from the attaching link being larger than the slot, bears out against the coupler tool housing. When a force is applied causing tension on Chain #1, the coupler engages with Chain #2 causing the coupler tool to act as an intermediate link connecting Chain #1 with Chain #2.

We presently contemplate for these embodiments the coupler tool Will be made of steel with a minimum tensile strength of 60 ksi and have an essentially circular cavity measuring 2⅛ inches in diameter, an engagement slot 1.16 inches wide measuring a minimum of 0.75 inches long from the slot opening to the ending drill center, and opposing chain link slot 0.389 inch wide measuring minimum of 0.50 inch long from the slot opening to the drill center. However, it can have other compositions, values, dimensions, measurements, sizes and materials.

### CONCLUSION, RAMIFICATIONS, AND SCOPE

Thus, the reader will see at least one embodiment of the Trailer Hitch-Ball Chain Coupler provides a reliable, light weight and economical multiple use tool that can be used by persons of almost any age.

While the above description contains various specificities, these should not be construed as limitations on the scope, but rather as an exemplification of the preferred embodiments thereof. Many other variations are possible. For example: the size of the tool and the various cavities can be adjusted in size, shape, dimension or measurement to accommodate a variety of sizes of trailer hitch-balls and similar devices, as well as variations for chain gauge or size.

Accordingly, the scope should be determined not by the embodiments illustrated, but by the appended claims and their legal equivalents.

We claim:

1. A coupling tool comprising:
a. a rigid contoured plate comprising: (1) a circular cavity positioned to one side of the plate which is intersected by an elongated slot along the centerline of the long axis of the plate. (2) a smaller elongated slot/notch opposing the aforementioned larger elongated slot intersecting the circular cavity along the centerline of the long axis of the plate. (3) an optional slot/notch intersecting the outboard apex of the larger elongated slot of (1) but opposite to the aforementioned circular cavity of (1).
